(19) United States
(12) Patent Application Publication
(10) Pub. No.: US 2005/0047991 A1
(43) Pub. Date: Mar. 3, 2005

(54) Method of stabilizing packaged active chlorine-containing solutions against light-induced degradation employing alkaline hypochlorite solutions in combination with a container

(76) Inventors: Wayne M. Rees, Racine, WI (US); Terry M. Kovara, Racine, WI (US)

Correspondence Address: S.C. JOHNSON & SON, INC., 1525 HOWE STREET, RACINE, WI, 53403-2236, US

(21) Appl. No.: 10/654,351

(22) Filed: Sep. 3, 2003

(51) Int. Cl. C01B 11/04

(52) U.S. Cl. 423/473

(57) ABSTRACT

A method of reducing light-induced degradation of alkaline hypochlorite solutions when packaged in a container which is in whole or in part transparent or semi-transparent is described. The method involves incorporating at least one UV blocker and at least one tinting agent in at least the transparent or semi-transparent portion of the container, incorporating a UV blocker-tinting agent combination in a wrap which overlays at least the transparent or semi-transparent portion of the container or incorporating at least one UV blocker and at least one tinting agent in a container and/or a wrap overlaying the container. The container and wrap is composed of plastic such as polyethylene terephthalate, polyethylene, polypropylene, polystyrene, or polyvinyl chloride. The UV blocker is present in a concentration of about 0.01-2.0% by weight. The tinting agent is present in a concentration of about 0.01-2.0% by weight. The UV blocker-tinting agent combination serves to provide reduction in transmission of UV and visible light in a wavelength range of from about 300-450 nm. The alkaline hypochlorite solution preferably contains sodium hypochlorite. The invention is also directed to the alkaline hypochlorite solution in combination with a container for the solution, the container being in whole or in part transparent or semi-transparent and having at least one UV blocker-tinting agent combination present in relation thereto.

### FIELD OF INVENTION

The invention is directed to a method of stabilizing packaged active-chlorine containing solutions against light-induced degradation, employing a combination of an alkaline hypochlorite solution with a container, wherein the packaging container is transparent or semi-transparent in whole or in part. The method and combination of the invention include providing a container having at least a portion thereof being transparent or semi-transparent and including at least one UV blocker and at least one tinting agent in relation to the transparent or semi-transparent portion. The UV blocker-tinting agent combination significantly reduces transmission of light in the wavelength range of about 300-450 nm to the alkaline hypochlorite solution.

### BACKGROUND OF THE INVENTION

Active chlorine-containing compounds are oxidizing chlorine-containing substances. This invention, in particular, is directed to materials which produce hypochlorous acid (HOCl) or hypochlorite ion (OCl⁻) in water. Common examples include sodium hypochlorite, hypochlorous acid, halogenated (N-chloro) cyanuric acid/cyanurates, halogenated (N-chloro) hydantoins, halogenated sulfamate (e.g. N-chlorosulfamates), and N-chloro derivatives of arylsulfonamides, glycouril, and melamine.

When dissolved in aqueous solutions, active chlorine-containing compounds are sensitive to light-induced degradation (photolytic decomposition). U.S. Pat. No. 2,988,471 discloses a method for stabilizing active chlorine solutions by reducing the degradation to the solutions caused by sunlight using cyanuric acid additives. Similarly, U.S. Pat. No. 4,187,293 discloses a method for stabilizing active chlorine solutions against degradation by UV light using imidodisulfonic acid, and salts thereof. These two methods were noted to be particularly useful in the photolytic stabilization of active chlorine compounds in swimming pools when exposed to sunlight.

For many types of cleaning and deodorizing applications, it is preferable to use liquid compositions since such are generally regarded as convenient and easy to use. Transparent or semi-transparent packaging is highly desirable for liquid household cleaner formulations for practical and/or aesthetic purposes. As compared to opaque containers, transparent and semi-transparent packaging can provide advantages for consumer dispensing, especially with regard to seeing the level of the product therein during dispensing and determining the extent of product use and, thus, when more product should be purchased. Consumers also prefer the aesthetics of “see-through” packaging, i.e., where the product is clearly visible. For example, a product may be colored to provide aesthetic appeal in itself and/or to suggest and complement a fragrance provided in the product.

Household and industrial cleaning products often contain active chlorine compounds for their cleaning, bleaching, biocidal, and deodorizing properties. Liquid cleaners containing active chlorine compounds which are packaged in transparent or semi-transparent containers, however, are susceptible to light-induced decomposition of the active chlorine compounds. For this reason, such cleaners are packaged in opaque containers to prevent the rapid loss of active chlorine when exposed to light from various sources such as indoor artificial lighting, sunlight through glass, unfiltered sunlight, and the like. Thus, cleaning products containing an active chlorine compound cannot take advantage of transparent or semi-transparent containers.

Accordingly, it would be advantageous to be able to provide a hypochlorite solution packaged in a container which is in whole or in part transparent or semi-transparent. Thus, more versatile container packaging would be available for hypochlorite solutions to address the needs and satisfy the aesthetic desires of the consumer.

### OBJECTS AND BRIEF DESCRIPTION OF THE INVENTION

Accordingly, it is a primary object of the invention to provide a method of protecting alkaline hypochlorite solutions against light-induced degradation when enclosed in a container which is in whole or in part transparent or semi-transparent.

It is a further primary object of the invention to provide a combination of an alkaline hypochlorite solution and container which is in whole or in part transparent or semi-transparent wherein the container protects the alkaline hypochlorite solution against light-induced degradation.

The present invention relates to active chlorine containing compositions herein referred to as “alkaline hypochlorite solutions”, and in particular to solutions which contain hypochlorite ion (OCl⁻) formulated in a pH range of about 10-14, preferably within a pH range of about 11.5-13.5. Aqueous alkaline hypochlorite solutions are generally formulated with alkali metal hypochlorite salts, most commonly sodium hypochlorite (NaOCl) based on, inter alia, widespread commercial availability and low cost. Other, less common sources of hypochlorite include alkaline earth hypochlorites (e.g. Ca(OCl)₂), chlorinated trisodium phosphate, and N-chlorinated derivatives of cyanurates/cyanuric acid, hydantoins, and sulfonamides. Representative alkaline hypochlorite solutions are exemplified by the compositions described in U.S. Pat. Nos. 4,282,109; 4,352,678; 4,599,186; 4,657,692; 4,789,495 and 6,200,941 B1.

Alkaline hypochlorite solutions packaged in conventional transparent or semi-transparent containers exhibit significant photolytic degradation of the active chlorine content when exposed to typical sources of light, such as fluorescent light and sunlight through glass. The present invention is directed to a method of inhibiting the photolytic degradation of alkaline hypochlorite solutions, when packaged in containers which are in whole or in part transparent or semi-transparent. This is accomplished by providing a combination of least one UV blocker and at least one tinting (coloring) agent in relation to the transparent or semi-transparent portion of the container. The UV blocker(s) and tinting agent(s) may be incorporated directly into the transparent or semi-transparent portion of the container or into a wrap positioned around the exterior of the container, or the UV blocker(s) or tinting agent(s) can be separately incorporated into a container and a wrap for the container used in combination. The wrap may be a film wrap or a bubble wrap. A “film wrap” is an overlayed plastic film in complete or near-complete contact with at least the transparent or semi-transparent container walls, whereas a “bubble wrap” is a plastic film which encompasses at least the transparent or semi-transparent container walls yet is largely separated from the container by a void space. Due to the presence of the tinting agent, the container and/or wrap will be tinted in the final product.

The UV blocker-tinting agent combination suitable for use preferably absorbs light in the wavelength range of about 300-450 nm. The UV blocker is present in a total concentration of about 0.01-2% by weight in the transparent or semi-transparent portion of a container or wrap. The tinting agent is present in a total concentration of about 0.01-2% by weight in the transparent or semi-transparent portion of a container or wrap. Examples of suitable plastic container resins include polyethylene terephthalate (PET), polyethylene (PE), polypropylene (PP), polyethylene terephthalate glycol (PETG), polyvinyl chloride (PVC), polystyrene (PS), and derivatives thereof.

### DETAILED DESCRIPTION OF PREFERRED EMBODIMENTS

The invention concerns a method of providing a an alkaline hypochlorite solution in a container which is in whole or in part transparent or semi-transparent, as well as the combination of the alkaline hypochlorite solution and the container. “Transparent” with reference to the container is understood to include colorless and colored (e.g. tinted) containers or portions of containers. “Semi-transparent” includes containers or portions of containers made for example from “natural” polyethylene, which has a slightly hazy appearance. “Transparent” and “semi-transparent” are used to describe container walls or wall portions, or wraps, which allow for the transmission of visible light therethrough such filled or partially filled container.

For long-term storage and stability of aqueous alkaline hypochlorite solution household cleaners, low energy UV light and high energy visible light, i.e., the combined wavelength spectrum of about 300-450 nm, are of practical concern from the standpoint of light-induced degradation of the active chlorine present in the cleaner. In particular, certain types of indoor lighting, such as sunlight through glass and fluorescent lighting, are of greatest concern since this type of lighting contains significant amounts of low energy UV light and high energy visible light and are commonly encountered in retail and household environments. Long-term exposure of alkaline hypochlorite cleaning product solutions to light in the wavelength range of about 300-450 nm will lead to undesirable degradation of these solutions.

The inclusion of a UV blocker-tinting agent combination in a transparent or semi-transparent container material, or provision of a wrap including a UV blocker-tinting agent combination for overlaying the transparent or semi-transparent container, or a container having a wrap thereon wherein the UV blocker(s) and the tinting agent(s) are separately contained in the container and wrap to provide a UV blocker-tinting agent combination, significantly reduces light-induced degradation of aqueous alkaline hypochlorite solutions. As used herein, the term “UV blocker” includes any single compound or combination of compounds which absorbs or reflects UV light, when incorporated into plastic package components, such that transmission of UV light to the container contents is reduced. As used herein, the term “tinting agent” includes any single compound or combination of compounds which absorbs or reflects visible light when incorporated into plastic package components, such that transmission of visible light to the container contents is reduced.

Transparent containers useful in the invention can be made of polyethylene terephthalate (PET) [including polyethylene terephthalate glycol (PETG)], polystyrene (PS), or polyvinyl chloride (PVC) resins. Such containers may either be colorless or tinted (colored). The tint may or may not be provided by a tinting agent which absorbs or reflects light within the defined wavelength range of the invention. If not, the tinting agent of the invention may be present in the container and/or a wrap for the container. The final container product therefore, whether due to tint in the container itself and/or tint in the wrap, will be colored due to the tinting agent. Semi-transparent containers useful in the invention preferably can be made of polyethylene (PE) or polypropylene (PP) resins which provide a slightly hazy appearance to the container made therefrom. Other transparent and semi-transparent container resins can also be employed, as long as they are compatible with the alkaline hypochlorite solutions. When the UV blocker(s) and/or tinting agents are incorporated into an outer wrap, the wrap may be of a form which contacts the container, such as a film wrap, or can be external package component, such as bubble wrap. Each encompasses the container in application.

A variety of UV blockers are manufactured for use as plastics additives. UV blockers suitable for use in the invention are UV blocker compounds which absorb low energy UV light. Absorbance of light is preferably in the wavelength range of from about 300-400 nm. The wavelength range of the light absorbed may vary outside the above range depending on the UV blocking compound(s) utilized. Representative examples of UV blockers suitable for use include TINUVIN 234, TINUVIN 326, and TINUVIN 1577 (sold by Ciba Speciality Chemicals, Inc.) and SANDUVOR VSU (an oxalanilide derivative) and SANDUVOR 3035 (a benzophenone) (sold by Clariant Corporation). Additional examples of UV blockers, suitable as additives for plastic packaging can be found in the Handbook of Industrial Chemical Additives (VCH Publishers) and 2002 McCutcheon's, Volume 2: Functional Materials, North American Edition (The Manufacturing Confectioner Publishing Co.). Suitable families of UV blockers which may be employed in the invention include benzophenones, benzotriazoles, oxalanilides, benzylidene malonates, phenyl substituted triazines, ultra-fine titanium dioxide and zinc oxide. Other classes of UV blocking plastic additives may also be useful. In some cases, UV blockers have been formulated directly into liquid compositions. However, UV blockers generally are not chemically stable or effective when formulated into active chlorine-containing solutions. As such, incorporation of the UV blocker into the resin used to provide a container or a wrap is highly advantageous.

A variety of tinting agents (colorants) are manufactured for use as plastic container additives. Tinting agents suitable for use in the invention are compounds (or mixtures of compounds) which absorb high energy visible light. Absorbance of light is preferably in the wavelength range of about 400-450 nm. The wavelength range of the light absorbed may vary outside the above preferred range depending on the tinting agent(s) utilized, providing the plastic container walls are semi-transparent to visible light within the wavelength range of about 450-800 nm and the container contents are visible through the container wall. Representative classes of tinting agents suitable for use include inorganic pigments, organic pigments, and organic dyes. Examples of tinting agents, suitable as additives for plastic packaging can be found in the Kirk-Othmer Encyclopedia of Chemical Technology (4^{th} Edition, Volume 6, Colorants for Plastics).

The UV blocker(s) can be incorporated into the transparent or semi-transparent portion of the container or wrap plastic in a concentration of from about 0.01 to 2.0% by weight, preferably about 0.05 to 0.5% by weight. The tinting agent(s) can be incorporated into the transparent or semi-transparent portion of the container or wrap plastic in a concentration of from about 0.01 to 2.0% by weight, preferably about 0.05 to 0.5% by weight. The amount of the UV blocker(s) and tinting agent(s) necessary for adequate photolytic protection of the alkaline hypochlorite solution may vary with variance in the wall thickness of the container or wrap. Greater amounts of UV blocker(s) and tinting agent(s) will be required for containers having relatively thin walls or wraps made of thin films. Ideally, the UV blocker(s) and tinting agent(s) are uniformly dispersed throughout the container plastic or wrap, or uniformly dispersed throughout the transparent or semi-transparent regions of the container or wrap.

In a preferred embodiment, a complete container for an alkaline hypochlorite solution is transparent or semi-transparent and has a UV blocker-tinting agent combination dispersed throughout the container structure. When a container is transparent or semi-transparent, in whole or in part, but does not contain a UV blocker-tinting agent combination within the plastic used to make the container, a wrap, preferably a film wrap or bubble wrap, can be placed encompassing the exterior wall of the container at least over the transparent or semi-transparent portions of the container. A container may be formed where only a portion of the container is transparent or semi-transparent, such as when a “window” is provided to view the container contents so that the product level can be readily determined. In accordance with the invention, the UV blocker-tinting agent combination can be incorporated into the material used to form the window and/or in a wrap for the window to prevent light-induced degradation of an alkaline hypochlorite solution held in the container.

Any vessel designed for long-term storage of an alkaline hypochlorite solution is to be construed as a container within the invention whether such container is independent or used in combination with another article or apparatus. For example, a transparent or semi-transparent liquid reservoir chamber intended to contain an alkaline hypochlorite solution forming part of a mechanical dispensing device is considered to be a container within the meaning of the invention.

The following examples are presented to illustrate preferred embodiments and utility of the present invention.

### EXAMPLE 1

Semi-transparent plastic PP bottles were prepared with and without UV blocker-tinting agent additives. The bottles were extrusion blow molded, having an average flat panel wall thickness of 0.040 inches, and a minimum wall thickness of about 0.014 inches.

A commercially available white opaque polyethylene bottle (PE) bottle was also utilized as an opaque control.

Transmittance spectra for the bottle plastic was obtained using flat panel sections cut from these containers, and scanned using a Hach DR/4000 UV/VIS spectrophotometer.

TABLE 1
% Light Transmittance Through
PP and PE Bottles +/− UV Blocker-Tinting Agent

| Wavelength | | | | | | Opaque |
|---|---|---|---|---|---|---|
| (nm) | PP-A | PP-B | PP-C | PP-D | PP-E | White PE |
| 320 | 39 | 0 | 0 | 0 | 0 | 0 |
| 360 | 48 | 0 | 0 | 0 | 0 | 0 |
| 400 | 55 | 4 | 5 | 5 | 8 | 0 |
| 440 | 60 | 3 | 3 | 2 | 3 | 0 |
| 550 | 69 | 31 | 26 | 16 | 2 | 0 |
| 600 | 73 | 14 | 33 | 37 | 10 | 0 |
| 700 | 77 | 18 | 44 | 52 | 38 | 1 |
| 800 | 82 | 35 | 52 | 62 | 52 | 1 |

PP-A = Colorless bottle formed from PP resin containing no UV blocker-tinting agent.
PP-B = Green bottle formed from PP resin containing added UV blocker-tinting agent combination 1.
PP-C = Yellow bottle formed from PP resin containing added UV blocker-tinting agent combination 2.
PP-D = Orange bottle formed from PP resin containing added UV blocker-tinting agent combination 3.
PP-E = Red bottle formed from PP resin containing added UV blocker-tinting agent combination 4.
Opaque white PE = Commercially available opaque white polyethylene bottle.

Thus, the data in Table 1 demonstrates that the inclusion of UV blocker-tinting agent combinations into the PP bottle resin greatly reduces the transmission of low energy UV and high energy visible light (about 300-450 nm) through the walls of the semi-transparent plastic PP bottle, yet allows for significant transmission of light in other regions of the visible light spectrum. As expected, the wall of the opaque white PE bottle transmits virtually no UV or visible light.

### EXAMPLE 2

### Alkaline Hypochlorite Solution

A representative aqueous alkaline hypochlorite solution was prepared using sodium hypochlorite, NaOCl, as the source of hypochlorite, and had the composition as set forth in Table 2 below.

TABLE 2
Representative alkaline hypochlorite
formulation

| | Weight % in |
|---|---|
| Ingredient | Formulation |
| Sodium Hypochlorite | 4.0 |
| Sodium Hydroxide | 1.0 |
| Lauryl Dimethyl Amine | 1.0 |
| Oxide Surfactant | |
| Sodium Silicate | 0.2 |
| Water | To 100% |

### EXAMPLE 3

### Evaluation of Photolytic Degradation

The representative alkaline hypochlorite solution described in Example 2 was packaged in the various semi-transparent PP bottles described in Example 1. The representative formulation of Example 2 was also packaged in the white opaque PE bottle (opaque control bottle). The solutions in their respective bottles were placed in a high intensity fluorescent light box and subjected to accelerated photolytic aging at ambient temperature (ca. 28° C.). The containers were periodically removed from the light box and the solutions therein analyzed for active chlorine content. The results of the analyses are provided in Table 3 below.

TABLE 3
Active Chlorine Loss In Various
Bottles-% NaOCl After Aging In Light Box

| | | | | Active |
|---|---|---|---|---|
| | | | | Chlorine |
| | | Day | DXay | Loss at |
| Bottle Type | Day 5 | 12 | 20 | Day 20 |
| Control = White opaque PE | 3.9 | 3.7 | 3.4 | 15% |
| bottle | | | | |
| PP-A | 3.4 | 2.7 | 1.9 | 52% |
| PP-B | 3.8 | 3.6 | 3.3 | 17% |
| PP-C | 3.9 | 3.7 | 3.6 | 10% |
| PP-D | 3.9 | 3.8 | 3.7 | 7% |
| PP-E | 3.9 | 3.7 | 3.6 | 10% |

The alkaline hypochlorite solution, packaged in the white opaque PE control container lost only 15% of the initial active chlorine content during the 20 day test period. In contrast, the alkaline hypochlorite solution packaged in the semi-transparent PP container without a UV blocker-tinting agent combination (PP-A) lost 52% of the initial active chlorine content. In comparison, samples in semi-transparent PP bottles which include a UV blocker-tinting agent combination (PP-B, PP-C, PP-D, and PP-E) exhibited 7-17% loss of active chlorine content after 20 days of high intensity photolytic aging. This is substantially less than samples packaged in the PP-A bottles without a UV blocker-tinting agent combination. Furthermore, the alkaline hypochlorite solutions packaged in semi-transparent PP bottles containing a UV blocker-tinting agent combination retained at least as much active chlorine as the opaque control bottle used in the testing.

The present invention thus advantageously provides a method of significantly reducing light-induced degradation of an alkaline hypochlorite solution packaged in a container which is transparent or semi-transparent, either in whole or in part. The combined alkaline hypochlorite solution and container provided result in a product having long term shelf-stability while allowing for visibility of the container contents. The invention allows for wide versatility in container structure for containers enclosing alkaline hypochlorite solutions.

As will be apparent to one skilled in the art, various modifications can be made within the scope of the aforesaid description. Such modifications being within the ability of one skilled in the art form a part of the present invention and are embraced by the appended claims.

1. A method of reducing light-induced degradation of alkaline hypochlorite solutions comprising
providing an alkaline hypochlorite solution, and
enclosing said alkaline hypochlorite solution in a container,
wherein at least a portion of said container is transparent or semi-transparent and said at least a portion of said container includes at least one UV blocker and at least one tinting agent therein so as to provide a reduction in transmission of UV light and visible light through said at least a portion of said container to said alkaline hypochlorite solution.

2. A method of reducing light-induced degradation of alkaline hypochlorite solutions comprising
providing an alkaline hypochlorite solution, and
enclosing said alkaline hypochlorite solution in a container,
wherein at least a portion of said container is transparent or semi-transparent and a transparent or semi-transparent wrap overlays at least said at least a portion of said container, and wherein at least one UV blocker and at least one tinting agent is present in said wrap overlaying said at least a portion of said container, or said at least one UV blocker and said at least one tinting agent is present in said container and/or said wrap, so as to provide a reduction in transmission of UV light and visible light through said wrap and/or said container to said alkaline hypochlorite solution.

3. A method according to claim 2, wherein said wrap is a film wrap material.

4. A method according to claim 2, wherein said wrap is bubble wrap material.

5. A method according to claim 1, wherein said at least one UV blocker and said at least one tinting agent are each present in a concentration of about 0.01-2.0% by weight of said at least a portion of said container.

6. A method according to claim 2, wherein said at least one UV blocker and said at least one tinting agent are each present in a concentration of about 0.01-2.0% by weight of said wrap or said container based on in which said at least one UV blocker and said at least one tinting agent is present.

7. A method according to claim 1, wherein said at least one UV blocker and said at least one tinting agent are each present in a concentration of about 0.05-0.5% by weight of said at least a portion of said container.

8. A method according to claim 2, wherein said at least one UV blocker and said at least one tinting agent are each present in a concentration of about 0.05-0.5% by weight of said wrap or said container based on in which said at least one UV blocker and said at least one tinting agent is present.

9. A method according to claim 1, wherein said UV light and said visible light are in a wavelength range of about 300-450 nm.

10. A method according to claim 2, wherein said UV light and said visible light are in a wavelength range of about 300-450 nm.

11. A method according to claim 1, wherein said at least one UV blocker is a benzophenone, benzotriazole, oxalanalide, benzylidene malonate, phenyl substituted triazine, titanium dioxide and/or zinc oxide.

12. A method according to claim 2, wherein said at least one UV blocker is a benzophenone, benzotriazole, oxalanalide, benzylidene malonate, phenyl substituted triazine, titanium dioxide and/or zinc oxide.

13. A method according to claim 1, wherein said at least one tinting agent is an inorganic pigment, organic pigment or organic dye.

14. A method according to claim 2, wherein said at least one tinting agent is an inorganic pigment, organic pigment or organic dye.

15. A method according to claim 1, wherein said at least one tinting agent absorbs light in a wavelength range of about 400-450 nm.

16. A method according to claim 2, wherein said at least one tinting agent absorbs light in a wavelength range of about 400-450 nm.

17. A method according to claim 1, wherein said alkaline hypochlorite solution comprises an aqueous mixture of sodium hypochlorite and sodium hydroxide and/or potassium hydroxide.

18. A method according to claim 2, wherein said alkaline hypochlorite solution comprises an aqueous mixture of sodium hypochlorite and sodium hydroxide and/or potassium hydroxide.

19. A method according to claim 1, wherein said container is a plastic container.

20. A method according to claim 2, wherein said wrap is plastic.

21. A method according to claim 19, wherein said plastic container is made from a polyethylene terephthalate resin, a polyethylene resin, a polypropylene resin, a polyvinyl chloride resin, a polystyrene resin, or derivative thereof.

22. A method according to claim 20, wherein said plastic is a polyethylene terephthalate resin, a polyethylene resin, a polypropylene resin, a polyvinyl chloride resin, a polystyrene resin, or a derivative thereof.

23. A method of reducing light-induced degradation of alkaline hypochlorite solutions comprising
providing an alkaline hypochlorite solution comprising an aqueous mixture of sodium hypochlorite and sodium hydroxide and/or potassium hydroxide, and
enclosing said alkaline hypochlorite solution in a plastic container,
wherein at least a portion of said container is transparent or semi-transparent and said at least a portion of said container includes at least one UV blocker and at least one tinting agent, wherein said at least one UV blocker and said at least one tinting agent are each present in a concentration of about 0.01-2.0% by weight therein so as to provide a reduction in transmission of UV light and visible light in a range of about 300 to 450 nm through said at least a portion of said container to said alkaline hypochlorite solution.

24. A method of reducing light-induced degradation of alkaline hypochlorite solutions comprising
providing an alkaline hypochlorite solution comprising an aqueous mixture of sodium hypochlorite and sodium hydroxide and/or potassium hydroxide, and
enclosing said alkaline hypochlorite solution in a plastic container,
wherein at least a portion of said container is transparent or semi-transparent and a transparent or semi-transparent wrap overlays said at least a portion of said container, and wherein at least one UV blocker and at least one tinting agent is present in said wrap overlaying said at least a portion of said container, or said at least one UV blocker and said at least one tinting agent is present in said container and/or said wrap, said at least one UV blocker and said at least one tinting agent each being present in a concentration of about 0.01-2.0% by weight, so as to provide a reduction in transmission of UV light and visible light in a range of about 300 to 450 nm through said wrap and/or said container to said alkaline hypochlorite solution.

25. A method according to claim 24, wherein said wrap is a film wrap material.

26. A method according to claim 24, wherein said wrap is bubble wrap material.

27. A method according to claim 23, wherein said at least one UV blocker and said at least one tinting agent are each present in a concentration of about 0.05-0.5% by weight of said at least a portion of said container.

28. A method according to claim 24, wherein said at least one UV blocker and said at least one tinting agent are each present in a concentration of about 0.05-0.5% by weight of said wrap or said container based on in which said at least one UV blocker and said at least one tinting agent is present.

29. A method according to claim 23, wherein said at least one UV blocker is a benzophenone, benzotriazole, oxalanalide, benzylidene malonate, phenyl substituted triazine, titanium dioxide and/or zinc oxide.

30. A method according to claim 24, wherein said at least one UV blocker is a benzophenone, benzotriazole, oxalanalide, benzylidene malonate, phenyl substituted triazine, titanium dioxide and/or zinc oxide.

31. A method according to claim 23, wherein said plastic container is made from a polyethylene terephthalate resin, a polyethylene resin, a polypropylene resin, a polyvinyl chloride resin, a polystyrene resin, or a derivative thereof.

32. A method according to claim 24, wherein said wrap is made from a polyethylene terephthalate resin, a polyethylene resin, a polypropylene resin, a polyvinyl chloride resin, a polystyrene resin, or a derivative thereof.

33. A method according to claim 23, wherein said at least one tinting agent is an inorganic pigment, organic pigment or organic dye.

34. A method according to claim 24, wherein said at least one tinting agent is an inorganic pigment, organic pigment or organic dye.

35. A method according to claim 23, wherein said at least one tinting agent absorbs light in a wavelength range of about 400-450 nm.

36. A method according to claim 24, wherein said at least one tinting agent absorbs light in a wavelength range of about 400-450 nm.

37. An alkaline hypochlorite solution in combination with a container comprising
an aqueous alkaline hypochlorite solution including an alkali metal hypochlorite and an alkali metal hydroxide, and
a container wherein at least a portion of the container is transparent or semi-transparent, and said at least a portion of the container includes at least one UV blocker and at least one tinting agent therein so as to provide a reduction in transmission of UV light and visible light through said at least a portion of the container to said hypochlorite solution,
wherein said hypochlorite solution is enclosed within said container.

38. An alkaline hypochlorite solution in combination with a container comprising
an aqueous alkaline hypochlorite solution including an alkali metal hypochlorite and an alkali metal hydroxide, and
a container wherein at least a portion of the container is transparent or semi-transparent and a transparent or semi-transparent wrap overlays at least said at least a portion of the container, and wherein at least one UV blocker and at least one tinting agent is present in said wrap overlaying said at least a portion of said container, or said at least one UV blocker and said at least one tinting agent is present in said container and/or said wrap, so as to provide a reduction in transmission of UV light and visible light through said wrap and/or container to said hypochlorite solution,
wherein said hypochlorite solution is enclosed within said container.

39. An alkaline hypochlorite solution in combination with a container according to claim 38, wherein said wrap is a film wrap material.

40. An alkaline hypochlorite solution in combination with a container according to claim 38, wherein said wrap is a bubble wrap material.

41. An alkaline hypochlorite solution in combination with a container according to claim 37, wherein said at least one UV blocker and said at least one tinting agent are each present in a concentration of about 0.01-2.0% by weight of said at least a portion of said container.

42. An alkaline hypochlorite solution in combination with a container according to claim 38, wherein said at least one UV blocker and said at least one tinting agent are each present in a concentration of about 0.01-2.0% by weight of said wrap or said container based on in which said at least one UV blocker and said at least one tinting agent is present.

43. An alkaline hypochlorite solution in combination with a container according to claim 37, wherein said at least one UV blocker and said at least one tinting agent are each present in a concentration of about 0.05-0.5% by weight of said at least a portion of said container.

44. An alkaline hypochlorite solution in combination with a container according to claim 38, wherein said at least one UV blocker and said at least one tinting agent are each present in a concentration of about 0.05-0.50% by weight of said wrap or said container based on in which said at least one UV blocker and said at least one tinting agent is present.

45. An alkaline hypochlorite solution in combination with a container according to claim 37, wherein said UV light and said visible light are in a wavelength range of about 300-450 nm.

46. An alkaline hypochlorite solution in combination with a container according to claim 38, wherein said UV light and said visible light are in a wavelength range of about 300-450 nm.

47. An alkaline hypochlorite solution in combination with a container according to claim 37, wherein said at least one UV blocker is a benzophenone, benzotriazole, oxalanalide, benzylidene malonate, phenyl substituted triazine, titanium dioxide and/or zinc oxide.

48. An alkaline hypochlorite solution in combination with a container according to claim 38, wherein said at least one UV blocker is a benzophenone, benzotriazole, oxalanalide, benzylidene malonate, phenyl substituted triazine, titanium dioxide and/or zinc oxide.

49. An alkaline hypochlorite solution in combination with a container according to claim 37, wherein said container is a plastic container.

50. An alkaline hypochlorite solution in combination with a container according to claim 49, wherein said plastic container is made from a polyethylene terephthalate resin, a polyethylene resin, a polypropylene resin, a polyvinyl chloride resin, a polystyrene resin, or a derivative thereof.

51. An alkaline hypochlorite solution in combination with a container according to claim 38, wherein said wrap is plastic.

52. An alkaline hypochlorite solution in combination with a container according to claim 51, wherein said plastic is a polyethylene terephthalate resin, a polyethylene resin, a polypropylene resin, a polyvinyl chloride resin, a polystyrene resin, or a derivative thereof.

53. An alkaline hypochlorite solution in combination with a container according to claim 37, wherein said at least one tinting agent is an inorganic pigment, organic pigment or organic dye.

54. An alkaline hypochlorite solution in combination with a container according to claim 38, wherein said at least one tinting agent is an inorganic pigment, organic pigment or organic dye.

55. An alkaline hypochlorite solution in combination with a container according to claim 37, wherein said at least one tinting agent absorbs light in a wavelength range of about 400-450 nm.

56. An alkaline hypochlorite solution in combination with a container according to claim 38, wherein said at least one tinting agent absorbs light in a wavelength range of about 400-450 nm.

57. An alkaline hypochlorite solution in combination with a container according to claim 37, wherein said alkali metal hypochlorite is sodium hypochlorite and said alkali metal hydroxide is sodium hydroxide and/or potassium hydroxide.

58. An alkaline hypochlorite solution in combination with a container according to claim 38, wherein said alkali metal hypochlorite is sodium hypochlorite and said alkali metal hydroxide is sodium hydroxide and/or potassium hydroxide.
